(19) United States
(12) Patent Application Publication
(10) Pub. No.: US 2010/0133864 A1
(43) Pub. Date: Jun. 3, 2010

(54) GRIPPING MEANS FOR USE WITH A UNIT INSERTABLE IN A PIPELINE

(76) Inventor: Harald Syse, Røyneberg (NO)

Correspondence Address: GABLE & GOTWALS, 100 WEST FIFTH STREET, 10TH FLOOR, TULSA, OK, 74103, US

(21) Appl. No.: 12/518,763

(22) PCT Filed: Dec. 12, 2007
(86) PCT No.: PCT/NO07/00438

§ 371 Date: Aug. 20, 2009

(30) Foreign Application Priority Data
Dec. 12, 2006 (NO) 2006 5746

(51) Int. Cl. F16L 55/00; E21B 23/01; E21B 33/129; F16L 55/128

(52) U.S. Cl. 294/92; 166/206

(57) ABSTRACT

The present invention related to gripping means for use with a unit (2) to be inserted into and held relative a pipeline (1), where the gripping means (3) comprises at least to gripping elements (300) arranged around the circumference of the main body (10) and formed with an outer surface (301) for contact with the internal wall of a pipeline. The outer surface of one gripping element in at least a part has a form giving two separate contact sections between the gripping element and an internal wall of a pipeline seen in a circumferential direction in an extended state of the gripping element.

The present invention relates to gripping means for use with a unit which should be hold relative an internal wall of a pipeline, and possibly seal against the internal wall, where the unit comprises a main body and actuation means for actuating the gripping means.

There is a general need for performing activities within a pipeline, for instance sealing off pipelines to performing maintenance, branching, repair etc of an already laid pipeline. There is also a need to stop more general pigs when one wants to perform a specific activity at one given location within a pipeline. This is normally achieved with anchoring or gripping means that has an outer form adapted to the specific pipeline wherein it should be stopped or set. The gripping means is shaped with an outer form which in an extended state of the gripping means forms a circumference, with a given diameter, similar to where it should be set and therefore full contact between the outer surface of the gripping means and the inner wall of the pipeline. However these gripping means will not give a good gripping effect with a pipeline with a different internal diameter.

Removable plugs and also pigs that are used within a pipeline and possibly stopped at desired locations should be adapted to be used for different internal diameters of a pipeline to get a most efficient use of the plugs and pigs. That gives more flexibility in the use of the plugs and pigs. There is therefore a general need to provide means to achieve a good gripping effect between the plug/pig and the pipeline, which gripping effect also is efficient with different internal diameters of the pipeline with the same gripping means.

There is therefore an aim with the present invention to provide gripping means for use with a unit that should be inserted into a pipeline. There is a further aim to provide gripping means that will have a good effect with different internal diameters of a pipeline. There is also an aim to provide gripping means that will work with a range of internal diameters of a pipeline.

These aims are achieved with griping means as described in the following claims.

The present invention regards gripping means for use with a unit to be stopped and possibly set within a pipeline. The gripping means is possible to use both with a pig that are pigged through a pipeline and which should be stopped at desired locations, and for plugs that should be stopped and set to seal off between two parts of the pipeline or seal against an inner wall of a pipeline, for a period of time and thereafter removed. A plug would also have sealing means arranged together with the unit. The unit comprises a main body and actuation means for actuating the gripping means between a retracted position to an extended position where the gripping means are in contact with an internal wall of a pipeline. The gripping means is comprising at least to gripping elements arranged around the circumference of the main body and where these gripping elements are formed with an outer surface for contact with the internal wall of a pipeline. Being two elements these are favorable positioned on opposite sides of the unit, in case there are more than two elements arranged around the circumference these are favorably arranged evenly around the circumference, however it is possible to envisage a non-evenly distribution around the circumference.

According to the invention an outer surface of one gripping element comprises in at least a part of the outer surface, a form giving at least two separate contact sections between the gripping element and an internal wall of a pipeline seen in a circumferential direction, in an extended state of the gripping element. By outer surface one should understand the surface of the gripping element facing an inner wall of the pipeline when the unit is inserted into the pipeline, either as an autonomous unit or connected to the outside by for instance an umbilical. The form or shape of the outer surface giving at least two contact sections sees in a circumferential direction for at least a part of the outer surface, gives the possibility of using the same gripping means for pipelines with different internal diameter and still have a good gripping between the gripping means and an internal wall of a pipeline. By at least a part of the outer surface one should understand that the outer surface may have areas forming the two contact section and these areas may be protruding in a radial direction relative the rest of the outer surface, and there may be other parts of the outer surface connecting the protruding surfaces and or forming frames around the protruding surfaces. There may also be one or more protruding area when seen in a direction of a longitudinal axis of the unit, mainly parallel with a longitudinal axis for the pipeline wherein the unit should be used. The protruding areas may also be formed with the borders of the areas forming a common line or there may be a non-protruding area of the outer surface between them.

According to an aspect of the invention the outer surface of one gripping element, in at least a part may comprise two convex arcs seen in a circumferential direction. This will give two contact sections between pipeline and gripping element, for pipelines with different internal diameters. The contact sections, between the gripping element and the pipeline wall, will be formed by different parts of the arcs dependent on the internal diameter of the pipeline. According to one aspect the arcs may be formed with an even curvature, or possibly with a varying curvature along the line of the arc.

In accordance with another aspect the outer surface of a gripping element may be inverted around a centre plane for the gripping element which centre plane comprises a longitudinal axis of the unit. This axis will be parallel to a longitudinal axis of the pipeline wherein the unit should be used.

According to a further aspect the gripping element may comprise a main part and at least one outer part attachable to the main part, which outer part forms at least a part of the outer surface of the gripping element. One possible solution is that at least a part of the outer surface of a gripping element seen in a circumferential direction may be formed by two attachable parts, forming the contact sections between the gripping element and an inner wall of a pipeline in an extended state of the gripping means. The two contact section may also be formed by one attachable part. Another possible solution is that at least a part of the outer surface of a gripping element seen in a longitudinal direction is formed by at least one attachable part. These outer attachable parts will also be replaceable with other attachable part possibly with same or a different outer configuration, either for the reason that they are worn, damaged or that one needs a different configuration of the outer surface of a gripping element. One may also combine these two solutions by having one or several parts in both circumferential and longitudinal directions. These attachable parts may form the protruding areas of the outer surface or both protruding areas and at least a part of a non-protruding area of the outer surface of a gripping element.

According to another aspect the outer surface of one gripping element at least in a part seen in a circumferential direction comprises a third section between the two convex arcs, which third section may be linear or have a different curvature than the two other section. This third section forms part of a non-protruding area of the outer surface, or with other word form a transitional section between two convex arcs.

According to another aspect the areas of the outer surface that may form contact sections between the gripping element and an inner wall of the pipeline may be provided with friction enhancing elements as teeth, ribs or other elements that possibly will dig themselves into the inner wall of the pipeline.

According to one aspect of the invention the gripping elements are formed by slips with an angled radial inner surface, which inner surface is adapted for abutting an angled outer surface of the main body of the unit. In such a solution the inner surface of the gripping elements and an end surface of the gripping element may comprise means for connecting the gripping element to a main body and the actuation means of the unit. This may possibly be a tongue and groove system, for instance with a T-shape, allowing movement between the parts in a length direction of the groove.

In a case where the unit is a plug, the plug may also comprise a sealing means arranged around the circumference of the plug main body, positioned next to the gripping means. The actuation means may be a centrally positioned fluid operated piston-cylinder arrangement, which may operate both the gripping and sealing means with one stroke of the piston through the cylinder chamber.

By such a device one has achieved a unit with gripping means that will give a good gripping effect for a range of internal diameters of a pipeline with the same gripping means.

The invention will now be explained in more detail with non-limiting embodiments with reference to the attached drawings where;

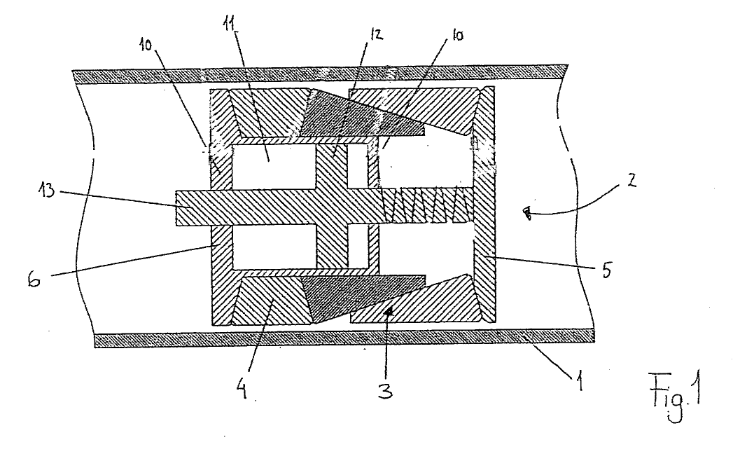

FIG. 1 depicts a schematic cross section along a longitudinal axis of a plug within a pipeline,

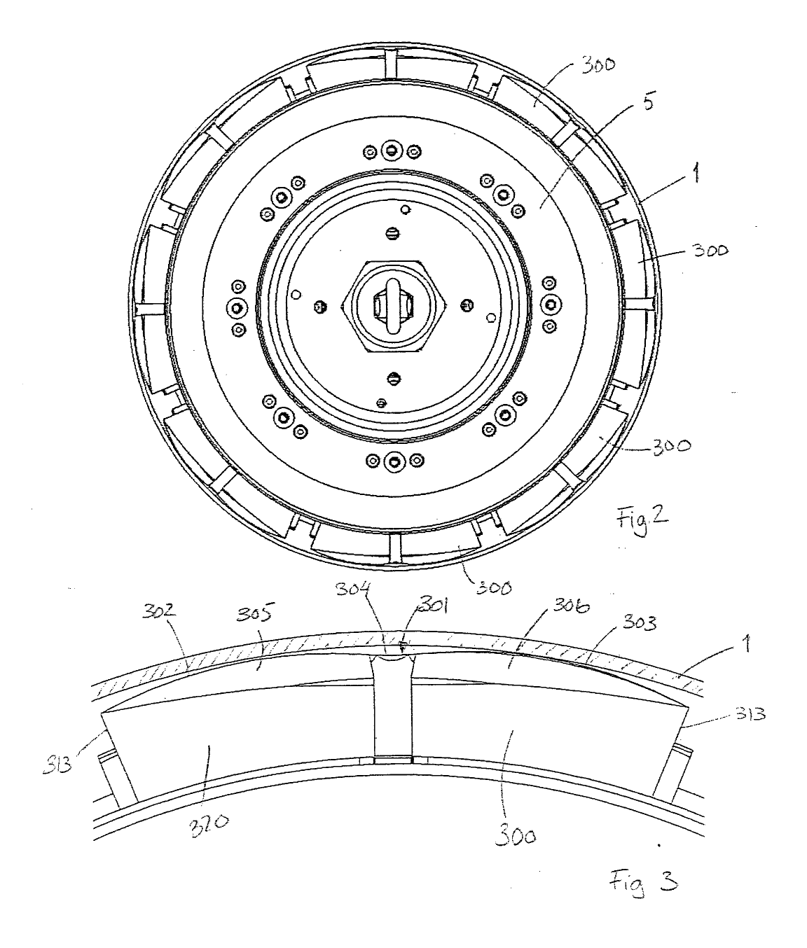

FIG. 2 show a plug seen from one end as it is set within a pipeline,

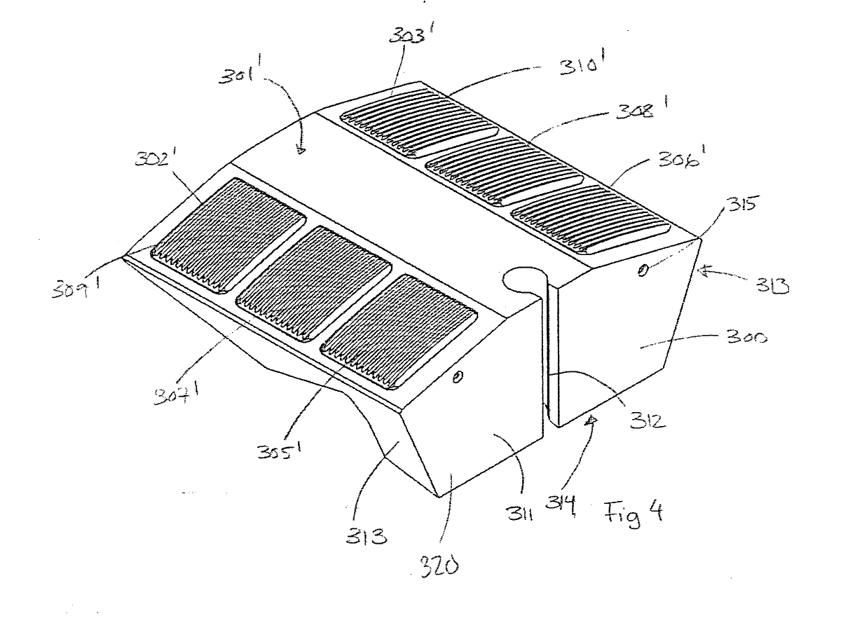

FIG. 3 shows a gripping element of FIG. 2 in more detail,

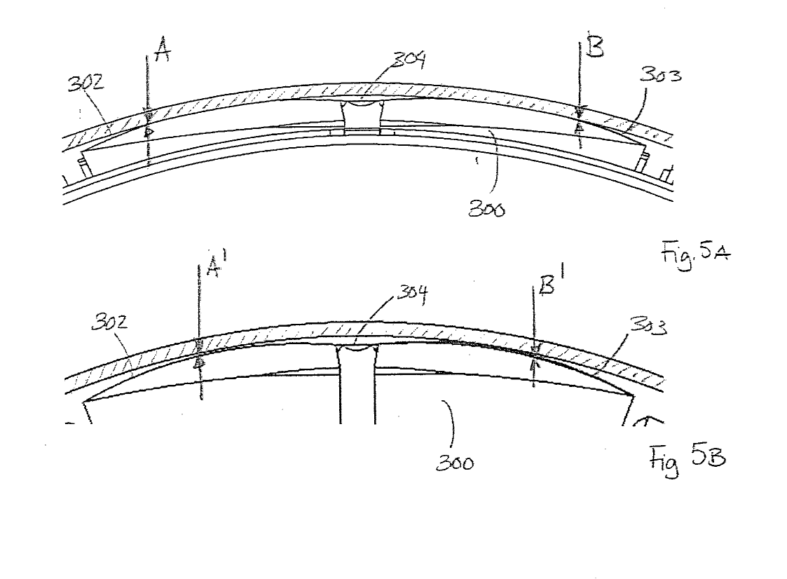

FIG. 4 shows an elevated view of a gripping element, and

FIG. 5A and 5B shows two pictures of a gripping element set in pipelines with different diameters.

In FIG. 1 there is shown a schematic sketch of a plug 2 positioned within a pipeline 1. The plug 2 comprises gripping means 3 and sealing means 4 arranged around the circumference of a main body 10 of the plug 2. The main body 10 comprises further actuation means in the form of a cylinder chamber 11 and a piston 12 movable within the chamber 11. The piston 12 is connected to a piston rod 13. Movement of the piston 12 relative in the chamber 11 will actuate the sealing means 4 and gripping means 3 from a retracted position as shown in FIG. 1 to an extended position where the gripping means 3 and sealing means 4 are in contact with the internal wall of the pipeline 1. During this movement of the piston 12, an end plate 6 of the plug 2 connected to the main body 10 is moved towards another end plate 5 of the plug 2 connected to the piston rod 13, and thereby moving slips of the gripping means 3 up along a conical surface formed by an element attached to the main body 10, and thereby moving the gripping means from a retracted to an extended position. The gripping means of the invention may of course be used with other kind of actuation means.

In FIG. 2 an embodiment of the gripping means 3 is shown arranged around the circumference of a unit as a plug within a pipeline 1 in an extended state of the gripping means. There gripping means comprises of eight gripping elements 300 around the circumference. In FIG. 3 one of these gripping elements 300 is shown in more detail. The gripping element 300 has an outer surface 301, which in the cross section transverse to a longitudinal axis of he plug, forms a first convex arc 302 and a second convex arc 303, with an intermediate part 304, which forms a concave arc. The first and second arc 302,303 is form by a first and second attachable part 305, 306 respectively. These attachable parts 305,306 are attachable to a main body 320 of the gripping element. There is also shown that the gripping element 300 has two side surfaces 313 stretching in a radial direction, giving the possibility of retracting the gripping elements to a position where a radial surface 313 of one gripping element is in abutment against a neighboring gripping element.

In FIG. 4 there is shown a somewhat different embodiment of a gripping element 300 seen in an elevated view. The gripping element 300 comprises six attachable parts 305′, 306′, 307′, 308′, 309′, 310′ respectively. These attachable parts are arranged in two rows with two part after each other in the circumferential direction and with three parts after each other in the longitudinal direction. The attachable parts are forming a curved section 302′, 303′ which will form contact sections with an inner wall of a pipeline. As shown there is between the attachable parts intermediate sections formed by the main body 320 of the gripping element 300, which together with the outer surface of the attachable parts form the outer surface 301′ of the gripping element, which outer surface is facing an inner wall of a pipeline. The main body comprises radial side surfaces 313 and an end surface 311, which end surface comprises a attachment groove 312, which will cooperate with a protrusion (not shown) on a part of the main body of the unit for attaching the gripping element to the unit. The gripping element also comprises an inner surface 314 which is angled in relation to a longitudinal axis and abutting a conical surface of the main body of the unit. There is also shown locking means 315 in the form of a hole and locking means within the hole for the different attachable parts 305′-310′.

In FIG. 5A and 5B one gripping element 300 is shown in an extended state in contact with two different pipelines, where the pipeline in FIG. 5A has a smaller radius than the pipeline in FIG. 5B. Three is shown that the contact sections where the gripping element is in contact with an inner wall of a pipeline is different for the pipelines with different diameter. The outer contact point are marked A and B in FIG. 5A and there is shown that these points are moved towards each other as A′ and B′ in FIG. 5B. As shown there are two contact section for the gripping element with pipelines of different internal diameters.

The invention has now been explained with embodiments, but a skilled person will understand that three may be made alterations and modifications to the embodiments within the scope of the invention as stated in the following claims. The gripping mean may be actuated from a retracted to an extended state by other means than a piston and cylinder arrangement. The gripping element may be of a different kind than slips. The gripping means may be used on a pig performing measurements, a plug sealing off the pipeline or a plug sealing against the pipeline but which plug allow a flow trough the plug after it is stopped in the pipeline. The unit may be moved in the pipeline by pigging and or by a tractor unit connected to or incorporated into the unit. There may also be several units liked in a train and also possibly connected with units without gripping means or with other kind of gripping means. There is also possible to envisage that there around the circumference of a unit is arranged gripping elements according to the present invention in between the gripping elements with only one contact section seen in a circumferential direction.

1. (canceled)

2. (canceled)

3. (canceled)

4. (canceled)

5. (canceled)

6. (canceled)

7. (canceled)

8. (canceled)

9. (canceled)

10. (canceled)

11. A gripping means for use with a unit to be inserted into and held relative to a pipeline, said unit comprising a main body and an actuation means for actuating the gripping means between a retracted position and an extended position where the gripping means are in contact with an internal wall of the pipeline, wherein the gripping means have at least two gripping elements arranged around the circumference of the main body and each formed with an outer surface adapted for contact with the internal wall of a pipeline, wherein the outer surface has at least two separate contact sections between the gripping element and an internal wall of a pipeline as seen in a circumferential direction when the gripping element is in the extended position, each said contact section has a convex arc as seen in a circumferential direction and being radially spaced apart by a respective intermediate non-convex section.

12. The gripping means according to claim 11, further comprising said arc formed with an even curvature.

13. The gripping means according to claim 11, further comprising said arc formed with a varying curvature along the line.

14. The gripping means according to claim 11, further comprising said outer surface of a gripping element is inverted around a centre plane for the gripping element which centre plane comprises a longitudinal axis of the unit.

15. The gripping means according to claim 11, further comprising at least a part of the outer surface of a gripping element seen in a circumferential direction is formed by at least one attachable part, forming the contact sections between the gripping element and an inner wall of a pipeline in an extended state of the gripping means.

16. The gripping means according to claim 11, further comprising at least a part of the outer surface of a gripping element seen in a longitudinal direction is formed by at least one attachable part.

17. The gripping means according to claim 11, said outer surface comprising a means to enhance friction between the gripping element and an inner wall of a pipeline.
